(19) United States
(12) Patent Application Publication
(10) Pub. No.: US 2016/0169621 A1
(43) Pub. Date: Jun. 16, 2016

(54) INTEGRATED SIGHT AND FIRE CONTROL COMPUTER FOR RIFLES AND OTHER FIRING MECHANISMS

(71) Applicants: Amir GEVA, Shoham (IL); Yitzhak LIECHTENSTEIN, Zichron Yaacov (IL)

(72) Inventors: Amir GEVA, Shoham (IL); Yitzhak LIECHTENSTEIN, Zichron Yaacov (IL)

(21) Appl. No.: 14/969,592

(22) Filed: Dec. 15, 2015

Related U.S. Application Data
(60) Provisional application No. 62/092,435, filed on Dec. 16, 2014.

(51) Int. Cl. F41G 1/40; F41G 3/06; G06G 7/78; F41G 3/14

(52) U.S. Cl. CPC F41G 1/40; F41G 3/14; F41G 3/06; G06G 7/78

(57) ABSTRACT

Described are devices for automated ballistic targeting that are attached to a rifle for firing ballistic ammunition, in which such rifle may have one or more barrels for use with one or more types of ammunition. Various embodiments use one or more mirrors and an optical splitter all of which may be position-fixed or adjustable, a collimator sub-system, a data input unit, and a ballistic computer, in which the elements are configured to provide a calculated ballistic trajectory to hit a target, to correct elevation and azimuth, and to generate an aiming point that is super-imposed visually on an image of the target when the rifle is correctly aimed to hit the target (even where the ballistic trajectory requires that the aim be on an elevation or an azimuth off the target). In various embodiments, errors in roll maybe indicated and corrected. In various embodiments, periscope functionality may be used.

### CROSS REFERENCE TO RELATED APPLICATION

The present application is related to and claims priority under 35 USC §120 to U.S. Provisional Application No. 62/092,435, filed on Dec. 16, 2014, which is hereby incorporated by reference.

### BACKGROUND

It is well known that ammunition fired from such rifles does not travel according to an optical line of sight, but rather according to a ballistic trajectory created primarily by the force of gravity and geometry (angle, distance to target, and pitch). The ballistic trajectory is also affected by many other factors, such as type of ammunition fired (specifically, the weight, drag, firing velocity of the ammunition), and weather conditions (particularly wind, but also humidity and temperature). In addition, the manner in which the rifle is held at the point of firing may result in roll, which is another pointing error primarily on the horizontal azimuth (although also potentially on the elevation).

As currently designed and manufactured, rifles, such as rifles and other mechanisms for firing ammunition, suffer from one or multiple disadvantages in dealing with problems of the ballistic trajectory. In some cases, there is no calculated correction for trajectory, so the user must estimate the changes in aiming that will be required. In such cases, the user must view the target, which often force the user to pulls the rifle off his shoulder or creates other problems with aiming. This problem—that the user must view the target—is particularly problematic when the user must point the rifle upwards, and hence the rifle can block the line-of-sight “LOS” from the user to the target.

In some cases a calculation of the ballistic trajectory is made, either by a person or a compute element such as a ballistic computer, but adjustments to the rifle sight must be made manually and are inexact.

Further, rifles are designed such that in order to hit a target, the user must fire above the target and possible to one side of the target. In these cases, the cross-hairs or other aiming point are not on the target, but are rather at the point at which the gun must be aimed. The natural tendency of the user to place an aiming point on the target, but that is not possible with current rifle design. The difference between optical line of sight to the target and the point at which the rifle must be aimed to hit the target is a problem with all firing rifles and types of ammunition, but is particularly damaging to accuracy for low-speed ammunition, encountering significant drag, that is fired at a target a relatively long distance from the user of the rifle.

### SUMMARY

Described herein are devices which may be integrated with, or attached to, rifles or other firing mechanisms, and that will improve the accuracy of hitting a target.

A first embodiment is an automated ballistic targeting device for attachment to, or integration with, a rifle for firing ballistic ammunition, in which the rifle uses one or more barrels to fire one or more than one type of ammunition. In one particular form of such embodiment, the device includes a ballistic computer that computes, according to various factors, the ballistic trajectory required to hit the target with the particular kind of ammunition to be fired. Also, the device includes one or more mirrors for adjusting elevation, each of which may be either in a fixed position or adjustable. If a mirror is adjustable, it may be adjusted manually, or by a motive force that automatically adjusts the position of the mirror in accordance with the calculated ballistic trajectory. The device includes also an optical splitter, which itself may be in a fixed position, or whose position may be adjustable either manually or by a motive force. The mirrors and/or the optical splitter are configured together to change their position, such that the sight shows to an user an aiming point on the target, and this occurs not when the rifle is aimed at the target according to an optical line of sight from the rifle to the target, but rather when the rifle is aimed with a different elevation to account for gravity in the ballistic trajectory and with a different horizontal aim to account for errors in azimuth. The device includes also a collimator sub-system, configured to generate the aiming point which will be super-imposed visually on the image of the intended target. The optical splitter is configured to super-impose the aiming point on the image of the target, again not according to the optical line of sight from the user to the target, but rather to the point at which the rifle must be aimed in order to hit the target according to the calculated ballistic trajectory. The user moves the rifle, and when the rifle is aimed at correct point to hit the target, the sight will show aiming point on the target (even though the rifle is not pointed at the target, but rather typically above the target and to one side of the target). The device includes also a data input unit configured to receive data and then provide information to the ballistic computer that allows the computer to compute the ballistic trajectory. Data may be received by the data input unit automatically from sensors, or by input supplied by the user or another person. In some embodiments, the rifle includes two or more barrels, each of which is enabled to fire one or more types of ammunition, and in this way the rifle is able to fire two or more types of ammunition. In some embodiments, the sight gives an indication of roll limits at the time of aiming or firing. In some embodiments, the sight gives a notice at the time of firing either that there is no (or acceptable small) roll, or that the aim is true on all factors (correct elevation, absence of or minimal pitch, absence of or minimal roll), such that the user may fire the rifle to hit the target.

A second embodiment is an automated ballistic targeting device for attachment to, or integration with, a rifle for firing ballistic ammunition, in which the rifle uses one or more barrels to fire one or more than one type of ammunition. In one particular form of such second embodiment, the second embodiment is different than that the first embodiment in that the second embodiment must have at least two mirrors for adjusting elevation (whereas in some forms of the first embodiment there may be one mirror) and the second embodiment includes at least one azimuth mirror (whereas there is not an azimuth mirror in the first embodiment).

In one particular form of the second embodiment, the device includes two mirrors for adjusting elevation, in which at least one of the mirrors is adjustable and each of the other mirrors may be either in a fixed position or adjustable. If a mirror is adjustable, it may be adjusted manually, or by a motive force that automatically adjusts the position of the mirror. The elevation mirrors are configured to show the target to the user when the rifle is corrected in elevation in order to hit a target. The device includes also one or more azimuth mirrors and an optical splitter, at least one of which (either an azimuth mirror or the optical splitter) is adjustable, and each of the other ones may be either in a fixed position or adjustable. If an azimuth mirror or optical splitter is adjustable, it may be adjustable either manually or by a motive force that automatically adjusts the position of the mirror or optical splitter. The azimuth mirrors and optical splitter are configured the target to the user when the rifle is corrected in azimuth in order to hit the target. The device includes also a collimator sub-system that is configured to generate an aiming point that is super-imposed on the image of the target, in which the optical splitter is configured to super-impose the aiming point on the target, such that the aiming point will be on the target not when there is an optical line of sight from the rifle to the target, but rather when the rifle is aimed at the correct point, typically above the target and to one side, such that if the rifle is fired then the ammunition, traveling in accordance with a calculated ballistic trajectory, will hit the target. The device includes also a ballistic computer configured to calculate the ballistic trajectory at which the rifle must be fired to hit a distant target. The device includes also a data input unit configured to provide information to the ballistic computer that allows the computer to compute the ballistic trajectory. In some embodiments, the sight gives an indication of roll limits at the time of aiming or firing. In some embodiments, the sight gives a notice at the time of firing either that there is no (or acceptable small) roll, or that the aim is true on all factors (correct elevation, absence of or minimal pitch, absence of or minimal roll), such that the user may fire the rifle to hit the target.

A third embodiment is a side-adjusted periscope for attachment to, or integration with, a rifle for firing ballistic ammunition, in which the rifle uses one or more barrels to fire one or more than one type of ammunition. In one particular form of such third embodiment, the periscope includes two mirrors for adjusting elevation, in which at least one of the mirrors is adjustable and each of the other mirrors may be either in a fixed position or adjustable. If a mirror is adjustable, it may be adjusted manually, or by a motive that automatically adjusts the position of the mirror. The elevation mirrors are configured to show the correct of the elevation of the rifle in order to hit a target.

The periscope includes also two or more azimuth mirrors, at least one of which is adjustable, and each of the other ones may be either in a fixed position or adjustable. If an azimuth mirror is adjustable, it may be adjustable either manually or by a motive that automatically adjusts the position of the mirror. The azimuth mirrors are configured to show the correct azimuth of the rifle in order to hit the target. The device includes also a ballistic computer configured to calculate the trajectory at which the rifle must be fired to hit a distant target. The device includes also a data input unit configured to provide information to the ballistic computer that allows the computer to compute the ballistic trajectory. Also in this form of the third embodiment, the periscope is aligned relative to another unit of the rifle such that the periscope is between the other unit and the target, and further such that the line of sight from the rifle to the target may be moved from, initially, the center of the rifle to the target, to, subsequently, the periscope to the target. In this way, the pitch of the rifle during aiming or during firing will not interrupt visual contact between the user of the rifle and the target. In this embodiment, the other unit on the rifle may be any unit that is used to create or enhance sighting of the target, including, for example, a day sight, a night sight, a telescopic sight, a video sight, and a thermal imaging sight.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1 illustrates one system according to the prior art in which the rifle is not adaptable for type of ammunition, and in which the field of view to the target is very limited.

FIG. 2 illustrates one system according to the prior art in which visual contact must be maintained between the user and the target.

FIG. 3 illustrates one embodiment of a system in which various embodiments of a targeting device may operate.

FIG. 4 illustrates one embodiment of the targeting device.

FIG. 5 illustrates another embodiment of the targeting device.

FIG. 6 illustrates one embodiment of a system in which various embodiments of a targeting device in periscope configuration may operate.

FIG. 7 represents one embodiment of a targeting device in a periscope configuration.

### DETAILED DESCRIPTION

Described herein are devices that may be integrated with, or attached to, rifles or other firing mechanisms, and that will improve the accuracy of hitting target. As described herein, such devices may be integrated with periscopes.

The term “rifle” as used herein means any device able to shoot at or through an object or objects in a ballistic trajectory. Some non-limiting examples include rifles, pistols, RPGs, rockets, mini-guns, machine-guns, arrow guns, or bows & arrows.

The term “sight” or “rifle sight” or “rifle sight”, as used herein, means a device used for aiming a rifle at a target. A “sight” may be optical, mechanical, digital, or some combination thereof, or of any other type provided that the device is used for aiming the rifle at the target.

The term “aiming point”, as used herein, means the place at which the rifle must be aimed in order to hit the target, as shown through the sight, and indicated typically by the intersection of cross-hairs, or by a dot, or by the center of a group of spokes, or the like. In the prior art, if the rifle must be aimed at a point higher or lower than a direct (or “optical”) line-of-sight “LOS” to the target, or to the left or right of the optical LOS to the target, the aiming point will be shown as the actual point at which the rifle must be aimed in order to hit the target, but will not show the aiming point on the target in any case where the ballistic trajectory requires that the rifle be aimed higher, lower, to the left, or to the right, of the target. In various embodiments as described herein, combination of mirrors and/or an optical splitter and/or optical wedge are adjusted such that even where ballistic trajectory requires that the rifle be aimed at an elevation or azimuth off the target (say, for example, a bit higher and a bit to the right of the target), when the rifle is pointed correctly in order to hit the target, the sight shows the aiming point directly on the target.

The term “visual unit”, as used herein, means a structural element such as a night vision, a telescope, a video camera, or any other component that enhances the image of the target, or records the image of the target, or processes the image of the target in some other way.

The term “fixed position”, as used herein, means that a particular element in placed in a certain position relative to elements, and the position of that particular element does not change. In contrast, the term “adjustable position”, as used herein, means that the position of a particular element may be changed, either automatically through a motive force or by manual adjustment, according to the particular embodiment.

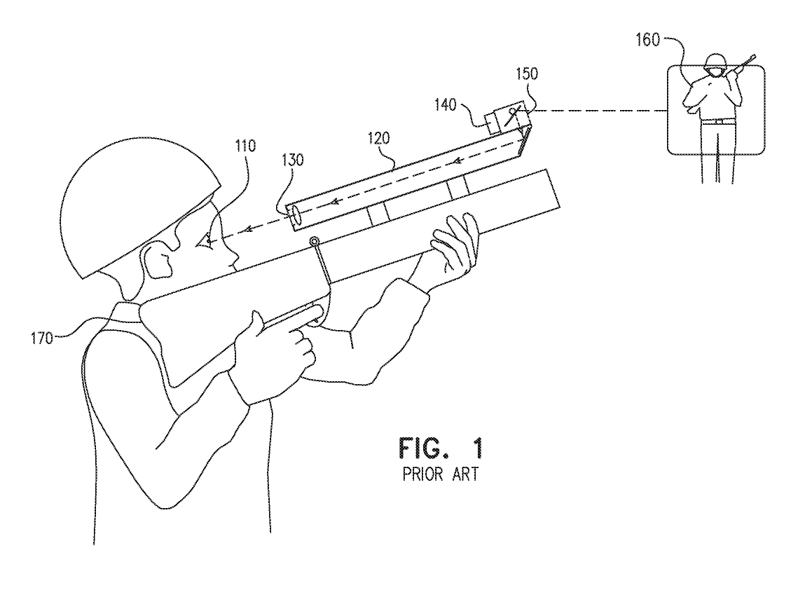

FIG. 1 illustrates one firing system according to the prior art. A user 110 is viewing a target 160 through a gun sight 120. Such gun sight 120 includes a window 150 for receiving the image of the target, and a knob or other mechanical mechanism 140 for manually adjusting the mirrors within the gun sight 120, such that after adjustment the sight will indicate clearly, usually with a dot or cross-hair, where the user must point the gun in order to hit the target. For example, let us assume that distance through the sight is measured in “clicks” or hash-marks, that each hash-mark represents 5 degrees on the vertical axis or 2 degrees on the horizontal axis, and that in order to hit the target, the rifle must be pointed 30 degrees in elevation and 6 degrees to the right. Thus, the aiming point of the rifle, in order to hit the target, will be 6 clicks (30 degrees divided by 5 degrees per click) elevated from the target, and three clicks (6 degrees divided by 2 degrees per click) to the right of the target. In this configuration, the butt of the rifle 170 is properly placed against the shoulder of the user 110.

The system illustrated in FIG. 1 has various disadvantages. There is no data input unit for inputting information related to environmental conditions that may affect the accuracy of the aiming. There is no ballistic computer for calculating automatically a ballistic trajectory that must be used in order to hit the target. The absence of a ballistic computer is particularly damaging to accurate aiming where the distance is great between the user 110 and the target 160 and/or where the type of ammunition fired is relatively low-velocity.

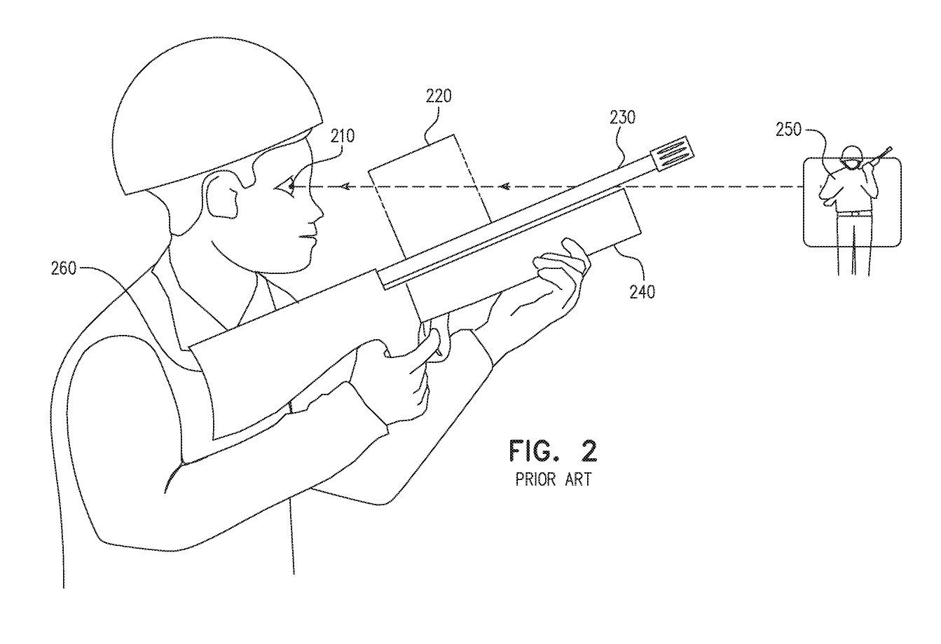

FIG. 2 illustrates one firing system according to the prior art. A user 210 views a target 250 through a gun sight 220. However, in order to correct the firing according to the ballistic trajectory, the user 210 must lower the rifle so that the user 210 has line-of-sight “LOS” to the target 250, and this lowering may remove the butt 260 of the rifle from the shoulder of the user 210. The lack of contact between the rifle butt 260 and the user's shoulder means that reduced support for the rifle at the time of firing, which may reduce accuracy. In the system illustrated in FIG. 2, there are two barrels, 230 for a bullet or other low-caliber ammunition and 240 for a grenade or other large type of ammunition. The ballistic trajectory required to hit the target 250 will be different based on the type of ammunition fired.

The system illustrated in FIG. 2 has various disadvantages. A human estimate of trajectory may be inaccurate, because it is not calculated to account for either type of ammunition or environmental factors. Further, the human estimate requires LOS from an user 210 to the target 250, which may require a lowering of the rifle off the shoulder of the user 210 (in order to unblock the LOS), but such lowering of rifle introduces a possible inaccuracy at the time of firing, as noted. In addition, the aiming point of the rifle is not fixed, but rather must be placed by the user 210 on the target 250, causing the user 210 to move the rifle until the aiming point is on the target 250. In the system illustrated in FIG. 2, the aiming point will show the point at which the rifle is aimed, but it will not show where the ammunition will actually arrive, such arrival point being affected by factors such as distance from the user 210 to the target 250, shape and weight of the ammunition to be fired, initial velocity of the ammunition to be fired, ambient temperature, ambient humidity, direction and speed of wind, and possibly other environmental factors.

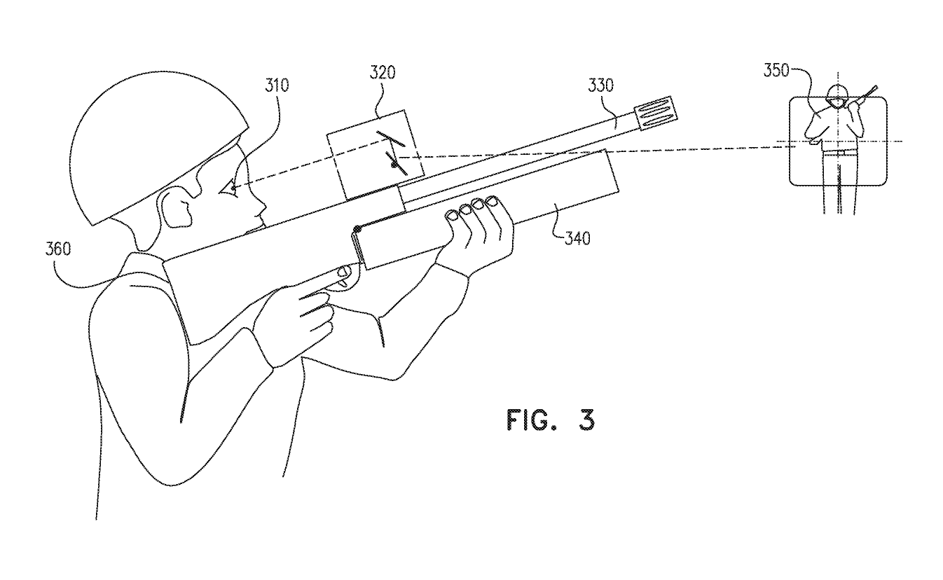

FIG. 3 illustrates one embodiment of a system in which various embodiments of the targeting device 320 may operate. In this embodiment, and according to the various embodiments described herein, the aiming point is the point at which the ammunition is expected to arrive—according to correct aiming, the user will see the aiming point super-imposed on the target. In FIG. 3, a user 310 views a target 350 through one embodiment of the device 320. In FIG. 3, there is not LOS from the user 310 to the target 350, but the device 320 eliminates the need for LOS. Two types of ammunition may be fired, indicated by a first barrel 330 for relatively small-caliber ammunition and a second barrel 340 for relatively larger ammunition or for explosive ammunition such as a grenade.

There are several advantages to the embodiment illustrated in FIG. 3. First, the user attempts to align the aiming point exactly on the target, rather than aligning the aiming higher than and to one side of the target. It is intuitively better, it is more natural, that the user aim the rifle such that the aiming point is on the target, rather than that the user aim deliberately to miss the target (even though he knows that gravity and other factors should adjust the miss into a hit). Second, this embodiment allows an user to hit the target while holding the rifle butt 360 on the user's 310 shoulder, while allowing the use of multiple ammunition and providing a wide filed of view due to the facts that the sight 320 is close to the eye of the user 310 and the sight is relatively short (in comparison to the sight shown in FIG. 1).

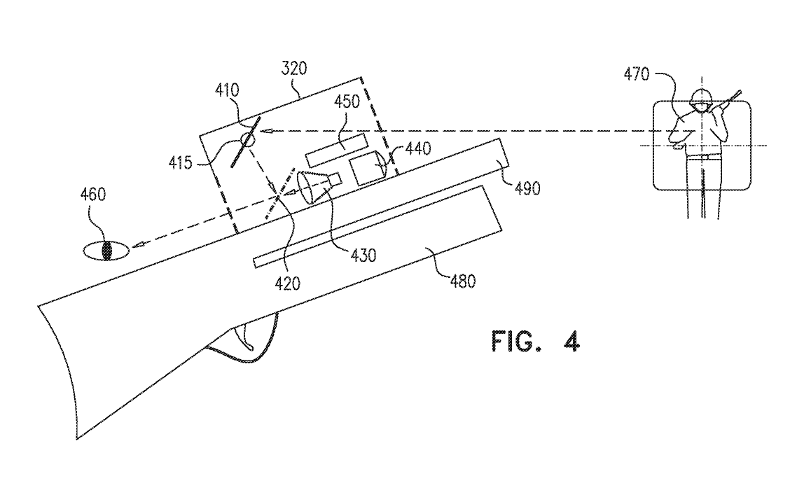

FIG. 4 illustrates one embodiment of the device 320, in greater detail than shown in FIG. 3, and placed within the operational environment. There is still a user 460 viewing a target 470 through the same device 320 as illustrated in FIG. 3. The rifle still includes two barrels 480, 490, indicating that two different types, or two different calibers, of ammunition may be fired by the rifle.

Within the particular embodiment of the device 320 illustrated in FIG. 4, there is a data input unit 440 that receives data from various sources (such as external sensors, or the user, or another person), and transmits the data as information to a ballistic computer 450 which calculates the ballistic trajectory required to hit the target. The data input unit 440 may receive, and then transmit to the ballistic computer 450, any kind of data relevant to aiming at and hitting the target, including, but not limited to, the distance or “range” from the rifle to the target, the type of ammunition to be fired (including, for example, its size, weight, shape, drag, and initial velocity), the rifle (including, for example, relative explosive power of a shot, length of the barrel, degree and direction of the spin placed on the ammunition) the target (including, for example, its size, shape, position, and nature), and the environment (including, for example temperature, relatively humidity, wind, dust or other particulates in the air). This information may be received from any number of sensors, which may be attached to the rifle, or which may be located externally to the rifle and which may communicate their data wirelessly to a receiver or transceiver in communicative contact with the data input unit 440. (Such a receiver or transceiver is not shown in FIG. 4.) For example, a range finder to determine the distance is not shown in FIG. 4, but the distance is a measure that will be discovered by some kind of range finding unit on the rifle, or rather not on he rifle but in some kind of communicative contact with the rifle (as by either wireless data communication, or by information conveyed verbally by a spotter for the user). As shown in FIG. 4, the data input unit 440 may be located within the device 320. Alternatively, the data input unit 440 may be located on the rifle but not within the device 320, or rather not on the rifle at all, but still in communicative contact with the ballistic computer 450. The user, or another person, may input the data to data input unit.

In alternative embodiments, the range finder may be attached to the rifle. In other alternative embodiments, the range finder may be attached to the targeting device, or integrated with the targeting device into a single unit with single housing.

In alternative embodiments, a visual unit may be attached to or integrated with the rifle, in order to provide, together with the targeting device, and enhanced ability to see and aim at the target, and/or an enhanced ability to record the action of aiming and firing at the target, and/or to improve the ability to convey visual images of the aiming and firing to persons or devices remote from the user and the rifle. Such images may be conveyed by a unit that communicates visual or auditory data in a wireless manner.

The ballistic computer 450 uses all, or at least some part, of the data received from the data input unit 440 to calculate a ballistic trajectory by which the rifle may fire the particular ammunition, in the current environmental conditions, and hit the target 470. As conditions change, the ballistic computer 450 may recalculate the required ballistic trajectory.

The device 320 will also include one or more mirrors to determine the correct elevation of the rifle in order to achieve the required ballistic trajectory. The embodiment of FIG. 4 illustrates a single elevation mirror 410, but this may also be achieved by two or more such elevation mirrors. At least one of the elevation mirrors, here 410, works in conjunction with an optical splitter 420 to produce an image of the target 470 to be shown to the user 460, including both the correct elevation of the rifle as previously discussed, and also the correct azimuth of the rifle to achieve the ballistic trajectory and hit the target 470. FIG. 4 illustrates also a collimator sub-system 430 which generates an aiming point. The optical splitter 420 takes the aiming point and places it on the target 470 when the user has aimed the rifle at the aiming point (not when the user has aimed the rifle at the target, for according to this embodiment, if the user aimed the rifle at the target point rather than the aiming point, the user would miss when he fired.). After the user 460 has fired, the sight 320 will, according to way it has been programmed, leave the aiming point as it is until the aiming point changes for the next target, or go back to a neutral position where the aiming point is at the place where the rifle would hit on an optical line of sight from the barrel of the rife. If the sight 320 has been programmed to go back to a neutral position, that may occur automatically after firing, or when the gun is placed down, or when the user inputs this intent into the data input unit 440, or after the passage of some predetermined time.

In FIG. 4, of the various elements, the elevation mirrors, here 410, and the optical splitter 420, at least one of them must be, and any of them may be, in an adjustable position, such that the adjustable components may adjust to show the user, through the sight, an aiming point for the selected target Adjustment of the position of any adjustable element may be manual, by the hand of the user, or may be automatic, by a motive force. FIG. 4 illustrates a motive force 415 that changes the position of adjustable elevation mirror 410, but as noted, any of the mirrors and the optical splitter may be in adjustable position, in which case they will be adjusted by a motive force which may be 415 or a different motive force not shown in FIG. 4. As used herein, “motive force” means a unit that creates a force to adjust the adjustable position of an element. A “motive force” might be, for example, some kind of motor (such as an actuator) or a chemical force (such as a battery) or another force.

In alternative embodiments, a range finder may be attached to the rifle. In other alternative embodiments, the range finder may be attached to the targeting device, or integrated with the targeting device into a single unit with single housing.

In alternative embodiments, a visual unit may be attached to or integrated with the rifle, in order to provide, together with the targeting device, and enhanced ability to see and aim at the target, and/or an enhanced ability to record the action of aiming and firing at the target, and/or to improve the ability to convey visual images of the aiming and firing to persons or devices remote from the user and the rifle. Such images may be conveyed by a unit that communicates visual or auditory data in a wireless manner.

One embodiment is and automated targeting device for attachment to a rife for a user to fire ballistic ammunition at a target, said rifle using one or more barrels with one or more than one type of ammunition. In one particular form of such embodiment, the device includes one or more mirrors for determining correct elevation, wherein each mirror may be in a fixed or adjustable position. Also in this particular form, the device includes an optical splitter, which may be in a fixed or an adjustable position. Also in this particular form, the device includes one or more motive forces for adjusting the positions of adjustable mirrors or an adjustable optical splitter. Also in this particular form, the device includes a collimator sub-system, a data input unit, and a ballistic computer. In some embodiments, the data input unit is configured to send a target range and an ammunition type to the ballistic computer, and the ballistic computer is configured to calculate a ballistic trajectory. In some embodiments, at least one of the mirrors or the optical splitter is in an adjustable position. In some embodiments, the mirrors and optical splitter are configured together to produce an image of the target, and to show a user the correct elevation and azimuth of the rifle to hit the target. In some embodiments, the collimator sub-system is configured to generate an aiming point to be super-imposed visually on the image of the target, such that even when the ballistic trajectory requires the rifle be aimed off the target, the targeting device will nevertheless show the aiming point on the target. In some embodiments, the optical splitter is further configured to super-impose, on the target, the aiming point generated by the collimator sub-system.

In an alternative to the embodiment for a targeting device just described, the device also includes inclinometer sensor configured to measure the correct pitch and roll of the rifle, and to provide to the user an optimal inclination to correct any error in the pitch or roll.

In a first configuration of the alternative just described, the targeting device further includes a range finder. In a first option of such first configuration, the mirrors and the optical splitter are further configured to maintain a direction of the range finder, such that even if the rifle moves, the range finder may continue to be directed at the target. In a second option of such first configuration, the targeting device further includes an additional sensor to improve the accuracy of the calculated ballistic trajectory. In a third option of such first configuration, the device further includes an optical wedge configured to move the azimuth position of the aiming point for greater accuracy in the azimuth.

In a second configuration of the alternative described above, the targeting device further includes a communication unit that is in communicative contact with a range finder that is external to the targeting device. In one option of such second configuration, the targeting device further includes an additional sensor to improve the accuracy of the calculated ballistic trajectory.

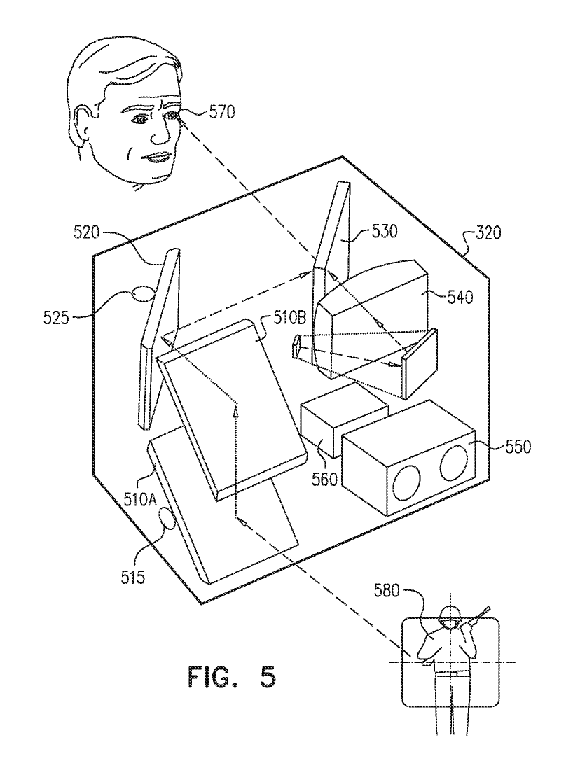

FIG. 5 illustrates one embodiment of the device 320, in greater detail than shown in FIG. 3. A user 570 is viewing a target 580 through the device 320. Within the particular embodiment of the device 320 illustrated in FIG. 5, there is an data input unit 550 that receives data from various sources, and transmits the data to a ballistic computer 560 which calculates the ballistic trajectory required to hit the target. The data input unit 550 may receive, and then transmit to the ballistic computer 560, any kind of data relevant to aiming at and hitting the target, including, but not limited to, the type of ammunition to be fired (including, for example, its size, weight, shape, and initial velocity), the target (including, for example, its size, shape, position, and nature), and the environment (including, for example temperature, relatively humidity, wind, dust or other particulates in the air). This information may be received from any number of sensors, which may be attached to the rifle, or which may be located externally to the rifle and which may communicate their data wirelessly to a receiver or transceiver in communicative contact with the data input unit 550. (Such a receiver or transceiver is not shown in FIG. 5.) As shown in FIG. 5, the data input unit 550 may be located within the device 320. Alternatively, the data input unit 550 may be located on the rifle but not within the device 320, or rather not on the rifle at all, but still in communicative contact with the ballistic computer 560.

The ballistic computer 560 uses all, or at least some portion, of the data received from the data input unit 550 to calculate a ballistic trajectory by which the rifle may fire the particular ammunition, in the current environmental conditions, and hit the target 580. As conditions change, the ballistic computer 550 may recalculate the required ballistic trajectory.

The device 320 will also include two or more mirrors to determine the correct elevation of the rifle in order to achieve the required ballistic trajectory. The embodiment of FIG. 5 illustrates two elevation mirrors 510A, 510B, but this may also be achieved by more than two such elevation mirrors. At least one of the elevation mirror 4s, 510A, 510B will be in an adjustable position, here 510A, such adjustment caused by a motive force 515, whereas the other elevation mirrors, here 510B, may be in an adjustable or fixed position, here shown in a fixed position. Further, there are one or more azimuth mirrors, here 520, which correct for the azimuth of the rifle. There is an optical splitter 530, which works together with the mirrors 510A, 510B, 520, to produce and show to the user 570 an image of the target 580 with the correct elevation and azimuth of the rifle to hit the target 580. At least one of the group of elements including the azimuth mirrors, here 520 and the optical splitter 530 is in an adjustable position that may be adjusted by a motive force 525, here the azimuth mirror 520 may be adjusted by motive force 525, and the other elements, here the optical splitter 530 may be in an adjustable or fixed position. If the other elements are in an adjustable position, they may be adjusted by the same motive force 525 or by a second or additional motive forces. Any of the motive forces, here 515, 525 may be motors, or chemical forces, or other forces that are enabled to move the position of a mirror or an optical splitter. Elements that are in adjustable position may be adjusted by the motive forces 515, 525, or manually, by the hand of the user 570. The elevation mirrors 510A, 510B, azimuth mirrors 520, and optical splitter 530, work together to produce and show to the user 570 an image of the target 580 with the correct elevation and azimuth to hit the target 580.

FIG. 5 includes also a collimator sub-system 540 which creates an aiming point. The optical splitter 530 takes the aiming point and places it on the target 580, in the same manner as discussed in FIG. 4 above.

A second embodiment is an automated ballistic targeting device for attachment to a rifle for a user to fire ballistic ammunition at a target, where such rifle has and uses one or more barrels with one or more than one type of ammunition. In one particular form of such embodiment, the ballistic targeting device includes two or more mirrors for determining correct elevation, wherein at least one of the mirrors is in an adjustable position, and the other elevation mirror or mirrors may be in a fixed or adjustable position. Also in such particular form, the device includes one or more mirrors for determining correct azimuth, wherein at least one of the mirrors is in an adjustable position, and the other azimuth mirror or mirrors may be in a fixed or adjustable position; Also in such particular form, the device includes an optical splitter, which may be in a fixed or an adjustable position, one or more motive forces for adjusting the positions of adjustable mirrors or an adjustable optical splitter, a collimator sub-system, a data input unit and a ballistic computer. In some embodiments the data input unit is configured to send a target range and an ammunition type to the ballistic computer, and the ballistic computer is configured to calculate a ballistic trajectory. In some embodiments, the mirrors and optical splitter are configured together to produce an image of the target, and to show a user the correct elevation and azimuth of the rifle to hit the target. In some embodiments, the collimator sub-system is configured to generate an aiming point to be super-imposed visually on the image of the target such that even when the ballistic trajectory requires the rifle be aimed off the target, the targeting device will nevertheless show the aiming point on the target. In some embodiments, the optical splitter is further configured to super-impose, on the target, the aiming point generated by the collimator sub-system.

In an alternative to the second embodiment for a targeting device just described, the device also includes inclinometer sensor configured to measure the correct pitch and roll of the rifle, and to provide to the user an optimal inclination to correct any error in the pitch or roll.

In a first configuration of the alternative just described, the targeting device further includes a range finder. In a first option of such first configuration, the mirrors and the optical splitter are further configured to maintain a direction of the range finder, such that even if the rifle moves, the range finder may continue to be directed at the target. In a second option of such first configuration, the targeting device further includes an additional sensor to improve the accuracy of the calculated ballistic trajectory. In a third option of such first configuration, the device further includes an optical wedge configured to move the azimuth position of the aiming point for greater accuracy in the azimuth.

In a second configuration of the alternative described above, the targeting device further includes a communication unit that is in communicative contact with a range finder that is external to the targeting device. In one option of such second configuration, the targeting device further includes an additional sensor to improve the accuracy of the calculated ballistic trajectory.

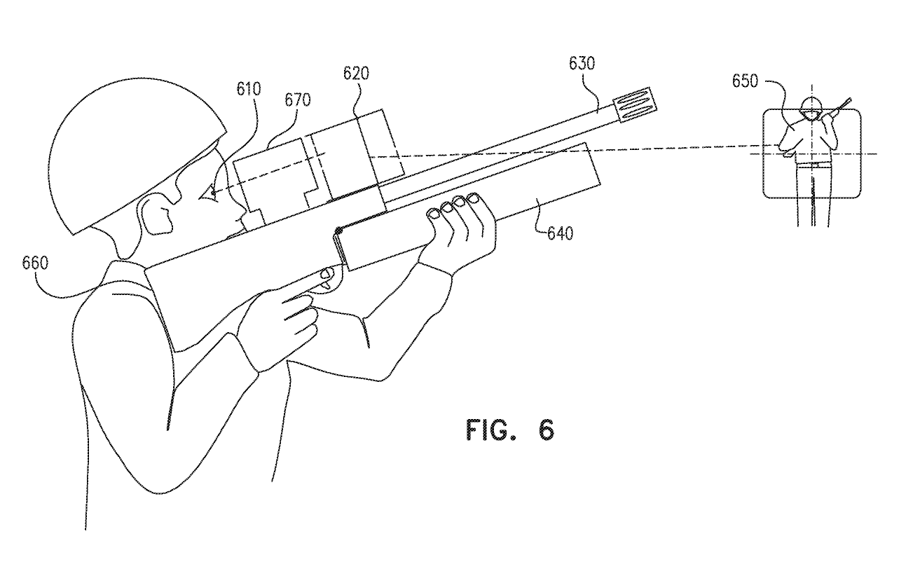

FIG. 6 illustrates one embodiment of a system in which various embodiments of a targeting device 620 in periscope configuration may operate. A user 610 does not have line-of-sight to a target 650, but views the target 650 through the device 620, which is located on a rifle. The rifle may have two or more barrels 630, 640, each barrel enabled to fire a different kind of ammunition. Alternatively, the rifle may have only one barrel, but that is not illustrated in FIG. 6. As shown in FIG. 6, since the user 610 can see the target 650 through the device 620, there is no need to lower the rifle, and hence the butt of the rifle 660 is placed and remains against the shoulder of the user 610.

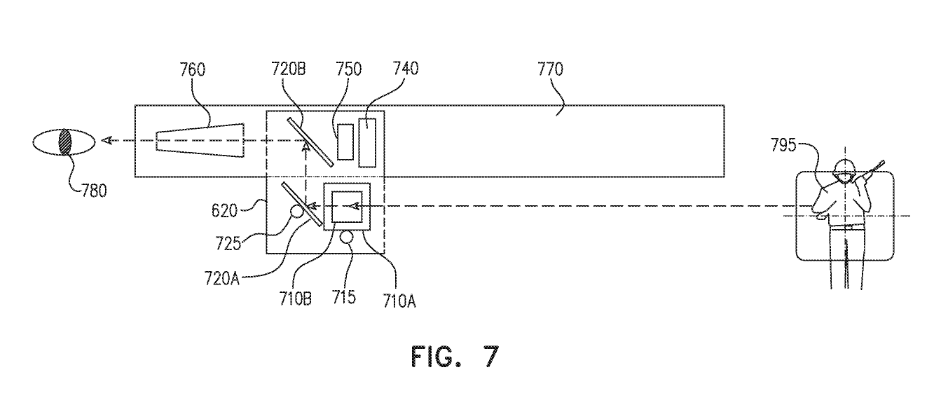

The device 620 is shown divided into two parts by a line segment, which separates between the part of the device that may be a periscope and part that may be for imaging the target, as further shown in FIG. 7. Also, there is an additional video unit, 670, between the user 610 and the target 650. This additional video unit may be a night vision, a telescope, a video camera, or any other component that enhances the image of the target, or records the image of the target, or processes the image of the target in some other way.

It should be understood that the periscope configuration shown in FIG. 6 may be used in situations where there is no LOS from the user to the target, but there is an LOS from a periscope located on the side of the rifle. This might be the case, for example where the target is far and large degree of elevation is needed and the barrel may interfere to see the target.

FIG. 7 represents one embodiment of a targeting device in a periscope configuration. In essence, there is shown, in a top down view, element 620 from FIG. 6 in greater detail, but shown here in a periscope configuration.

An user 780 views a target 795 through the device 620 shown in FIG. 6, where this device 620 includes eight elements, where 720B, 740, and 750 are in the top of 620 and 710A, 710B, 715, 720A, and 725 are in the bottom of 620. Note that in the top down view of FIG. 7, at least one barrel would be seen, here 770, but not necessarily both barrels, since the higher barrel would obscure the view of the lower barrel. There is an additional video unit 760, which as noted previously may be any unit that enhances, captures, or otherwise processes the image of the target, here 795. The device 620 as illustrated in FIG. 7 includes the periscope, which is the lower part of 620 and which extends to the right of a vertical plane defined by the barrels of the rifle. The periscope function is used in order to be able to see the target where there is severe blockage of LOS between the user 780 and 795, or where the user 780 wishes not to expose himself so allows LOS between the periscope and the target 795 but not between the target and either the upper part of 620 or the user.

The targeting device 620 includes a data input unit 740 which receives and then transfers to a ballistic computer 750 data related to targeting the image 795, including data about the distance to the target, about the rifle, about the type of ammunition to be fired, about the target 795, and about the environmental conditions. The ballistic computer 750 calculates a ballistic trajectory required to hit the target 795. FIG. 7 illustrates also two elevation mirrors, 710A, 710B, in which at least one of them must be in adjustable position, here 710A, to be adjusted by a motive force 715. Light passes the elevation mirrors 710A, 710B, to two azimuth mirrors 720A, 720B, in which at least one of them must be in an adjustable position, here 720A, to be adjusted by a motive force 725. The combination of mirrors shows the correct elevation, from 710A, 710B and correct azimuth, from 720A, 720B of the rifle in order to hit the target 795. The image 795, with correct elevation and azimuth, is passed through the additional visual unit 760 to the user 780.

In some embodiments, all parts of the device 620 make up a single physical unit, within a single housing. In other embodiments, the two parts of the device 620 shown in FIG. 7 may different attachments to the rifle. FIG. 7 shows one possible division of components of the device 620 into upper and lower parts, but in other embodiments the division of components may be different, provided that there is a lower part that extends beyond (to the side) of the vertical plane defined by the rifle, and that the image of the target 795 comes through an opening or window in the part that extends beyond the vertical plane of the rifle, that is, as shown in FIG. 7, in the lower part of 620. In some embodiments, notably as shown in FIG. 7, there is no optical splitter or collimator sub-system, and hence the user 780 must move the rifle in order to place an aiming point on the image of the target 795. In embodiments without an optical splitter or collimator sub-system, the rifle will include a built-in aiming point, optionally within the additional visual unit 760. In other embodiments, not shown in FIG. 7, the device includes also an optical splitter and a collimator sub-system, in which case an aiming point is generated and super-imposed on an image of the target, similar to the configurations shown and discussed with regard to FIGS. 3, 4, and 5, but here, in FIG. 7, with the addition of a periscope function.

In some embodiments, there is a sensor that is on or in communicative contact with the rifle and that communicates to the user the roll of the rifle. The roll can have a serious impact on the accuracy of firing a rifle, particularly on the azimuth (although also possibly on elevation), particularly for shots with a relatively long distance from the rifle to the target, and particularly with relatively low-velocity ammunition (for example, a grenade that is relatively much lower in firing velocity than a higher velocity bullet, the former requiring a much higher arc to achieve the target). (For example, a rocket-propelled grenade “RPG” in flight might achieve 300 meters per second, versus an 5.56 mm bullet which might achieve 900 meters per second or higher). As one example, firing a grenade at a target of distance 300 meters, but with a 2 degree roll of the rifle, might create an inaccuracy as much as 5 meters.

The sensor could measure the roll, convey this information to the rifle either directly or through a data input unit, and indicate the degree of roll in some way. For example, there could be a flashing light on the sight to indicate to the user that the roll is excessive, where the speed of the flash is higher as the degree of roll increases. Alternatively, there might be a number on the sight, indicating to the user the degree of roll, as say +2 meaning “2 degrees too much clockwise” or −2 meaning “2 degrees too much counterclockwise. Alternatively, there might be a red light on the screen to indicate excessive roll, and the light might turn to green when the rifle is in position to hit the target.

In alternative embodiments, a range finder may be attached to the rifle. In other alternative embodiments, the range finder may be attached to the targeting device, or integrated with the targeting device into a single unit with single housing.

In alternative embodiments, a visual unit may be attached to or integrated with the rifle, in order to provide, together with the targeting device, and enhanced ability to see and aim at the target, and/or an enhanced ability to record the action of aiming and firing at the target, and/or to improve the ability to convey visual images of the aiming and firing to persons or devices remote from the user and the rifle. Such images may be conveyed by a unit that communicates visual or auditory data in a wireless manner.

A third embodiment is a side-adjusted periscope for attachment to a rifle for a user to fire ballistic ammunition at a target, in which the rifle has and uses one or more barrels with one or more than one type of ammunition. In one particular form of such embodiment, the periscope includes two or more mirrors for determining correct elevation, wherein at least one of the mirrors is in adjustable position, and the other mirror or mirrors may be in a fixed or adjustable position. The periscope includes also two or more mirrors for determining correct azimuth, wherein at least one of the mirrors is in adjustable position, and the other mirror or mirrors may be in a fixed or adjustable position. The periscope includes also one or more motive forces for adjusting the positions of the mirrors that are adjustable. The periscope includes also a data input unit and a ballistic computer. In some embodiments, the data input unit is configured to send a target range and an ammunition type to the ballistic computer, the ballistic computer is configured to calculate a ballistic trajectory. In some embodiments, the mirrors for determining correct elevation are configured together to produce an image of the target, and to show the user the correct elevation of the rifle to hit the target, and the mirrors for determining correct azimuth are configured together to show the user the correct azimuth of the rifle to hit the target. In some embodiments, the periscope is aligned relative to another visual unit of the rifle such that the periscope is between the other unit and the target, and further such that the line of sight from the rifle to the target may be moved from the center of the rifle to the side of the rifle, such that there is no line of sight from the center of the rifle to the target but there is line of sigh from the periscope to the target.

In a first alternative to the third embodiment just described, there is also an inclinometer sensor configured to measure the correct pitch and roll of the rifle, and to provide to the user an optimal inclination to correct any error in the pitch or roll. In a first configuration of such alternative embodiment, the periscope includes also a range finder.

In a second alternative to the third embodiment described above, there is a range finder that is external to the periscope, but that is in communicative contact with a communication unit that is part of, or connected to the periscope, where such communication unit receives range information from the external range finder and feeds it to the ballistic computer.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagram illustrates non-limiting embodiment/case example of the methods, and block diagrams illustrate non-limiting embodiment/case examples of the devices. Some operations in the flow diagram may be described with reference to the embodiments/cases illustrated by the block diagrams. However, the method of the flow diagram could be performed by embodiments/cases of the invention other than those discussed with reference to the block diagrams, and embodiments/cases discussed with reference to the block diagrams could perform operations different from those discussed with reference to the flow diagram. Moreover, although the flow diagram may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, a system may include multiple compute elements, each of which is communicatively connected to multiple servers, even though specific illustrations presented herein include only one compute element or a maximum of two compute elements.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. An automated ballistic targeting device for attachment to a rifle for a user to fire ballistic ammunition at a target, said rifle using one or more barrels with one or more than one type of ammunition, comprising:
one or more mirrors for determining correct elevation, wherein each mirror may be in a fixed or adjustable position;
an optical splitter, which may be in a fixed or an adjustable position;
one or more motive forces for adjusting the positions of adjustable mirrors or an adjustable optical splitter;
a collimator sub-system;
a data input unit; and
a ballistic computer;
wherein the data input unit is configured to send a target range and an ammunition type to the ballistic computer;
wherein the ballistic computer is configured to calculate a ballistic trajectory;
wherein at least one of the mirrors or the optical splitter is in an adjustable position;
wherein the mirrors and optical splitter are configured together to produce an image of the target, and to show a user the correct elevation and azimuth of the rifle to hit the target;
wherein the collimator sub-system is configured to generate an aiming point to be super-imposed visually on the image of the target, such that even when the ballistic trajectory requires the rifle be aimed off the target, the targeting device will nevertheless show the aiming point on the target; and
wherein the optical splitter is further configured to super-impose, on the target, the aiming point generated by the collimator sub-system.

2. The targeting device of claim 1, further comprising an inclinometer sensor configured to measure the correct pitch and roll of the rifle, and to provide to the user an optimal inclination to correct any error in the pitch or roll.

3. The targeting device of claim 2, further comprising a range finder.

4. The targeting device of claim 3, wherein the mirrors and the optical splitter are further configured to maintain a direction of the range finder, such that even if the rifle moves, the range finder may continue to be directed at the target.

5. The targeting device of claim 3, further comprising an additional sensor configured provide data to improve the accuracy of the calculated ballistic trajectory.

6. The targeting device of claim 3, further comprising an optical wedge configured to move the azimuth position of the aiming point for greater accuracy in the azimuth.

7. The targeting device of claim 2, further comprising a communication unit that is in communicative contact with a range finder that is external to the device.

8. The targeting device of claim 7, further comprising an additional sensor configured to provide data to improve the accuracy of the calculated ballistic trajectory.

9. An automated ballistic targeting device for attachment to a rifle for a user to fire ballistic ammunition at a target, said rifle using one or more barrels with one or more than one type of ammunition, comprising:
two or more mirrors for determining correct elevation, wherein at least one of the mirrors is in an adjustable position, and the other elevation mirrors may be in a fixed or adjustable position;
one or more mirrors for determining correct azimuth, wherein at least one of the mirrors is in an adjustable position, and the other azimuth mirrors may be in a fixed or adjustable position;
an optical splitter, which may be in a fixed or an adjustable position;
one or more motive forces for adjusting the positions of adjustable mirrors or an adjustable optical splitter;
a collimator sub-system;
a data input unit; and
a ballistic computer;
wherein the data input unit is configured to send a target range and an ammunition type to the ballistic computer;
wherein the ballistic computer is configured to calculate a ballistic trajectory;
wherein the mirrors and optical splitter are configured together to produce an image of the target, and to show a user the correct elevation and azimuth of the rifle to hit the target;
wherein the collimator sub-system is configured to generate an aiming point to be super-imposed visually on the image of the target such that even when the ballistic trajectory requires the rifle be aimed off the target, the targeting device will nevertheless show the aiming point on the target; and
wherein the optical splitter is further configured to super-impose, on the target, the aiming point generated by the collimator sub-system.

10. The targeting device of claim 9, further comprising an inclinometer sensor configured to measure the correct pitch and roll of the rifle, and to provide to the user an optimal inclination to correct any error in the pitch or roll.

11. The targeting device of claim 10, further comprising a range finder.

12. The targeting device of claim 11, wherein the mirrors and the optical splitter are further configured to maintain a direction of the range finder, such that even if the rifle moves, the range finder may continue to be directed at the target.

13. The targeting device of claim 11, further comprising an additional sensor configured to provide data to improve the accuracy of the calculated ballistic trajectory.

14. The targeting device of claim 11, further comprising an optical wedge configured to move the azimuth position of the aiming point for greater accuracy in the azimuth.

15. The targeting device of claim 10, further comprising a communication unit that is in communicative contact with a range finder that is external to the device.

16. The targeting device of claim 15, further comprising an additional sensor configured to provide data to improve the accuracy of the calculated ballistic trajectory.

17. A side-adjusted periscope for attachment to a rifle for a user to fire ballistic ammunition at a target, said rifle using one or more barrels with one or more than one type of ammunition, comprising:
two or more mirrors for determining correct elevation, wherein at least one of the mirrors is in adjustable position, and the others may be in a fixed or adjustable position;
two or more mirrors for determining correct azimuth, wherein at least one of the mirrors is in adjustable position, and the others may be in a fixed or adjustable position;
one or more motive forces for adjusting the positions of adjustable mirrors;
a data input unit; and
a ballistic computer;
wherein the data input unit is configured to send a target range and an ammunition type to the ballistic computer;
wherein the ballistic computer is configured to calculate a ballistic trajectory;
wherein the mirrors for determining correct elevation are configured together to produce an image of the target, and to show the user the correct elevation of the rifle to hit the target;
wherein the mirrors for determining correct azimuth are configured together to show the user the correct azimuth of the rifle to hit the target; and
wherein the periscope is aligned relative to another visual unit of the rifle such that the periscope is between the other unit and the target, and further such that the line of sight from the rifle to the target may be moved from the center of the rifle to the side of the rifle. such that there is no line of sight from the center of the rifle to the target but there is line of sigh from the periscope to the target.

18. The periscope of claim 17, further comprising an inclinometer sensor configured to measure the correct pitch and roll of the rifle, and provide to the user an optimal inclination to correct any error in the pitch or roll.

19. The periscope of claim 18, further comprising a range finder.

20. The periscope of claim 17, further comprising a communication unit that is in communicative contact with a range finder that is external to the periscope.
